(19) United States
(12) Patent Application Publication
(10) Pub. No.: US 2025/0386849 A1
(43) Pub. Date: Dec. 25, 2025

(54) METHOD AND DEVICE FOR PREDICTING PRINT QUALITY OF 3D PRINTER FOR PRINTING GROCERIES

(71) Applicant: TOP TABLE Inc., Seoul (KR)

(72) Inventor: Hyun Ju YOO, Seoul (KR)

(73) Assignee: TOP TABLE Inc., Seoul (KR)

(21) Appl. No.: 18/840,597

(22) PCT Filed: Feb. 20, 2023
(86) PCT No.: PCT/KR2023/002377

§ 371 Date: Apr. 18, 2025

(30) Foreign Application Priority Data
Feb. 22, 2022 (KR) 10-2022-0022964

(51) Int. Cl. A23P 20/20; B33Y 50/00; G06N 3/0455

(52) U.S. Cl. CPC A23P 20/20; B33Y 50/00; G06N 3/0455

(57) ABSTRACT

According to an embodiment of the present disclosure, a method for predicting printing quality of a 3D printer configured to print food may include classifying process factors of the 3D printer into a plurality of groups, inputting input data corresponding to the classification result into a model for predicting the printing quality, and obtaining a label indicating the printing quality by using output data output from the model.

### BACKGROUND

### Field of the Invention

The following embodiments relate to a method and an apparatus for predicting printing quality of a 3D printer configured to print food.

### Description of the Related Art

3D food printing technology is a food manufacturing technology that reconstructs food ingredients in three dimensions by layering them one by one based on a three-dimensional digital design created through CAD or a 3D scanner, after reflecting food composition ratios, nutritional data, and the like.

It may freely design the shape and texture of existing foods by combining essential foods such as grains, meat, and vegetables with new structural features through 3D printing, and may produce individual foods with completely different food compositions, tastes, and flavors, so it may be applied to various food industries.

Process factors of 3D printers have a great influence on the printing quality of the output. Even if the output is printed using the same sample, the quality of the output may vary depending on the process factors set in the 3D printer. Optimization of the process factors is necessary to print the output without failure, but since the correlation between the process factors and the quality of the output has not been precisely identified, it has been difficult to optimize the process factors. Therefore, a user of an existing food 3D printer had a problem in predicting the quality of the output until the printing was completed.

### SUMMARY

The present disclosure provides a method and an apparatus for predicting printing quality of a 3D printer configured to print food.

Objects to be achieved by the present disclosure are not limited to the objects mentioned above, and other objects and advantages of the present disclosure that are not mentioned may be understood by the following description, and will be more clearly understood by the embodiments of the present disclosure. In addition, it will be understood that the objects and advantages to be achieved by the present disclosure may be realized by the means and combinations thereof indicated in the appended claims.

According to an aspect, a method for predicting printing quality of a 3D printer configured to print food may include: classifying process factors of the 3D printer into a plurality of groups; inputting input data corresponding to the classification result into a model for predicting the printing quality; and obtaining a label indicating the printing quality by using output data output from the model.

In the above-described method, the classifying may include classifying the process factors into a plurality of groups based on their influence on the printing quality.

In the above-described method, the input data may include data generated through normalization of the process factors.

In the above-described method, the model may include the same number of autoencoders as the plurality of groups and a single deep neural network.

In the above-described method, the inputting of the input data corresponding to the classification result into the model for predicting the printing quality may include obtaining latent variables output from each of the autoencoders; and inputting the latent variables into the single deep neural network.

In the above-described method, the obtaining of the latent variables may include extracting an n^{th} latent variable by inputting input data included in an n^{th} group among the plurality of groups and a latent variable of an (n−1)^{th} group into the autoencoder, wherein the n includes a natural number greater than or equal to 2.

The above-described method may further include training the model using a backpropagation algorithm.

According to another aspect, an apparatus for predicting printing quality of a 3D printer configured to print food may include: a communication module configured to perform communication; a memory in which at least one program is stored; and a processor configured to perform an operation by executing the at least one program, wherein the processor is configured to classify process factors of a food 3D printer into a plurality of groups, input input data corresponding to the classification result into a model for predicting the printing quality, and obtain a label indicating the printing quality by using output data output from the model.

According to another aspect, a non-transitory computer-readable recording medium having recorded thereon a program for executing the method of the present disclosure on a computer is provided.

According to the means for solving problems of the present disclosure as described above, it is possible to predict the printing quality of the output of the food 3D printer.

According to one of the means for solving problems of the present disclosure, it is possible to predict the printing quality in advance before the printing is completed, thereby improving the convenience of the user.

### BRIEF DESCRIPTION OF THE DRAWINGS

FIG. 1 is a block diagram illustrating a method for predicting printing quality of a 3D printer configured to print food according to an embodiment of the present disclosure.

FIG. 2 is a diagram for explaining an example of classifying process factors of a 3D printer into a plurality of groups according to an embodiment of the present disclosure.

FIG. 3 is a diagram for explaining an example of a model for predicting printing quality of a 3D printer configured to print food according to an embodiment of the present disclosure.

FIG. 4 is a block diagram for explaining an example of extracting latent variables according to an embodiment of the present disclosure.

FIG. 5 is a diagram for explaining an example of inputting input data into a prediction model according to an embodiment of the present disclosure.

FIG. 6 is a diagram for explaining an example of predicting printing quality using output data output from a prediction model according to an embodiment of the present disclosure.

FIG. 7 is a block diagram for explaining an example of training a prediction model using a backpropagation algorithm according to an embodiment of the present disclosure.

FIG. 8 is a diagram for explaining an example of training a prediction model using a backpropagation algorithm according to an embodiment of the present disclosure.

FIG. 9 is a block diagram illustrating a printing quality prediction apparatus according to an embodiment of the present disclosure.

### DETAILED DESCRIPTION

General terms that are currently widely used as much as possible have been selected as terms used in the present embodiments while considering the functions in the present embodiments, but this may vary depending on the intention of those skilled in the art, precedents, the emergence of new technologies, and the like. In addition, in certain cases, there are terms arbitrarily selected by the applicant, and in this case, the meaning will be described in detail in relevant parts of the detailed description. Therefore, the terms used in the present embodiments should be defined based on the meaning of the term and the overall content of the present embodiments, rather than simply the name of the term.

The terms used in the present embodiments have the same meaning as generally understood by those skilled in the art to which the present embodiments belong, unless otherwise defined. Terms defined in commonly used dictionaries should be interpreted as having a meaning consistent with the meaning they have in the context of the relevant technology, and should not be interpreted in an ideal or excessively formal sense, unless explicitly defined in the present embodiments.

The present embodiments may have various modifications and may take various forms, and some embodiments will be illustrated in the drawings and described in detail. However, this is not intended to limit the present embodiments to a specific disclosure form, but should be understood to include all modifications and alternatives included in the spirit and technical scope of the present embodiments. The terms used herein are used only to describe the embodiments and are not intended to limit the present embodiments.

The detailed description of the present disclosure described below refers to the accompanying drawings, which illustrate specific embodiments in which the present disclosure may be implemented. These embodiments are described in sufficient detail to enable those skilled in the art to practice the present disclosure. It should be understood that the various embodiments of the present disclosure, while different from each other, are not necessarily mutually exclusive. For example, specific shapes, structures, and characteristics described herein may be modified and implemented from one embodiment to another without departing from the spirit and scope of the present disclosure. It should also be understood that the positions or arrangements of individual components within each embodiment may be changed without departing from the spirit and scope of the present disclosure. Accordingly, the following detailed description is not to be taken in a limiting sense, and the scope of the present disclosure is to be taken to encompass the scope of the claims and all equivalents thereof. In the drawings, similar reference numerals represent the same or similar components throughout.

In addition, terms including ordinal numbers such as first, second, may be used to describe various components, but the components should not be limited by the terms. The terms are used only for the purpose of distinguishing one component from another component.

When a component is said to be “connected” or “accessed” to another component, it should be understood that it may be directly connected or accessed to that other component, but there may also be other components in between. On the other hand, when a component is said to be “directly connected” or “directly accessed” to another component, it should be understood that there are no other components in between.

Hereinafter, embodiments of the present disclosure will be described in detail with reference to the accompanying drawings so that those skilled in the art may easily practice the present disclosure. However, the present disclosure may be implemented in many different forms and is not limited to the embodiments described herein.

Hereinafter, various embodiments of the present disclosure will be described in detail with reference to the accompanying drawings so that those skilled in the art may easily practice the present disclosure.

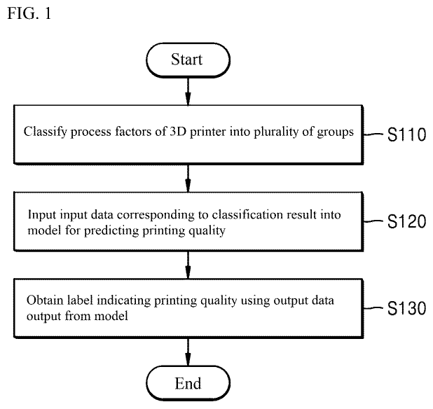

Conventional food 3D printers may have lower precision and accuracy than outputs from general 3D printers due to the characteristics of food samples. In other words, even if the same sample is used to output the same output, the printing quality of the output may vary depending on process factors set for the output of the food 3D printer. According to conventional technology, there was a problem in that it was difficult to immediately confirm the quality of the output because it was difficult to optimize the process factors according to the quality of the output. Meanwhile, a method and apparatus for predicting printing quality of a 3D printer configured to print food according to an embodiment of the present disclosure may immediately confirm the quality of the output of the 3D printer, thereby resolving the above-described problem. Hereinafter, a method and apparatus for predicting printing quality of a 3D printer according to an embodiment of the present disclosure will be described with reference to FIGS. 1 to 9.

FIG. 1 is a block diagram illustrating a method for predicting printing quality of a 3D printer configured to print food according to an embodiment of the present disclosure.

Referring to FIG. 1, a processor may classify process factors of a 3D printer into a plurality of groups (S110).

Process factors refer to important factors that greatly affect the printing quality of a 3D printer. For example, process factors may include various factors that affect the quality of the output, such as the size of the nozzle, the moving speed of the nozzle, the extrusion speed, the food material used, and the print speed of the 3D printer.

The processor may classify the process factors into a plurality groups according to the degree to which the process factors affect the printing quality. In more detail, the processor classifies the process factors into a plurality of groups according to the degree to which the process factors affect the printing quality.

For example, unlike general 3D printers, the quality of the output of a food 3D printer is greatly affected by the external temperature and humidity. Therefore, the process factors may include the external temperature and the external humidity.

For example, based on the degree to which the process factors affect the printing quality, the process factors may be classified into a plurality of groups as shown in [TABLE 1] below. [TABLE 1] includes 48 process factors for the food 3D printer and a total of 50 process factors, including the external temperature and humidity. According to [TABLE 1], it may be confirmed that 50 process factors are classified into 4 groups based on the degree to which they affect the printing quality. [TABLE 1] is only an example of classifying process factors into a plurality of groups and does not limit the number of process factor items and classified groups.

TABLE 1

| 1st group | 2nd group | 3rd group | 4th group |
|---|---|---|---|
| Nozzle Size | Wall Line Width | Wall Flow | Outer Wall Wipe |
| | | | Distance |
| Layer Height | Outer Wall Line | Outer Wall Flow | Initial Bottom Layers |
| | Width | | |
| Line Width | Inner Wall(s) Line | Inner Wall(s) Flow | Top/Bottom Pattern |
| | Width | | |
| Printing Temperature | Top/Bottom Line | Top/Bottom Flow | Bottom Pattern |
| | Width | | Initial Layer |
| Print Speed | Infill Line Width | Infill Flow | Seam Corner |
| | | | Preference |
| External | Initial Layer Line | Infill Speed | Infill Pattern |
| Temperature | Width | | |
| Humidity | Wall Thickness | Wall Speed | Printing Temperature |
| | | | Initial Layer |
| Infill Density | Wall Line Count | Top/Bottom Speed | Outer Wall Speed |
| Initial Printing | Top/Bottom | Travel Speed | Inner Wall Speed |
| Temperature | Thickness | | |
| Final Printing | Top Thickness | Initial Layer Speed | Initial Layer Travel |
| Temperature | | | Speed |
| Flow | Top Layers | Initial Layer Print | |
| | | Speed | |
| Initial Layer Flow | Bottom Thickness | Combining Mode | |
| | Bottom Layers | Avoid Printed Parts | |
| | | When Traveling | |
| | Z Seam Alignment | | |
| | Infill Line Distance | | |

Hereinafter, for the convenience of explanation, the term ‘process factor’ refers to a value representing the corresponding process factor.

The processor may input input data corresponding to the classification result into a model for predicting printing quality (S120).

For example, the input data may be generated through a normalization process of the process factors. Since each process factor has a different mean value and variance for each process factor, the input data must be generated through a normalization process in order to be applied to a model for predicting printing quality.

For example, the processor may generate input data by performing maximum-minimum normalization on the process factors. The maximum-minimum normalization may be performed through [Formula 1] below.

$${x}_{scaled} = \frac{x - {x}_{min}}{{x}_{max} - {x}_{min}} \qquad [ Formula 1 ]$$

xₘₐₓ is the maximum value of the process factor preset in the model for predicting printing quality, and xₘᵢₙ is the minimum value of the process factor preset in the model for predicting printing quality. In addition, x is the process factor value of the food 3D printer for predicting printing quality, and x_{scaled} is the input data generated through the normalization process.

Thereafter, the processor may input the input data into the model for predicting printing quality.

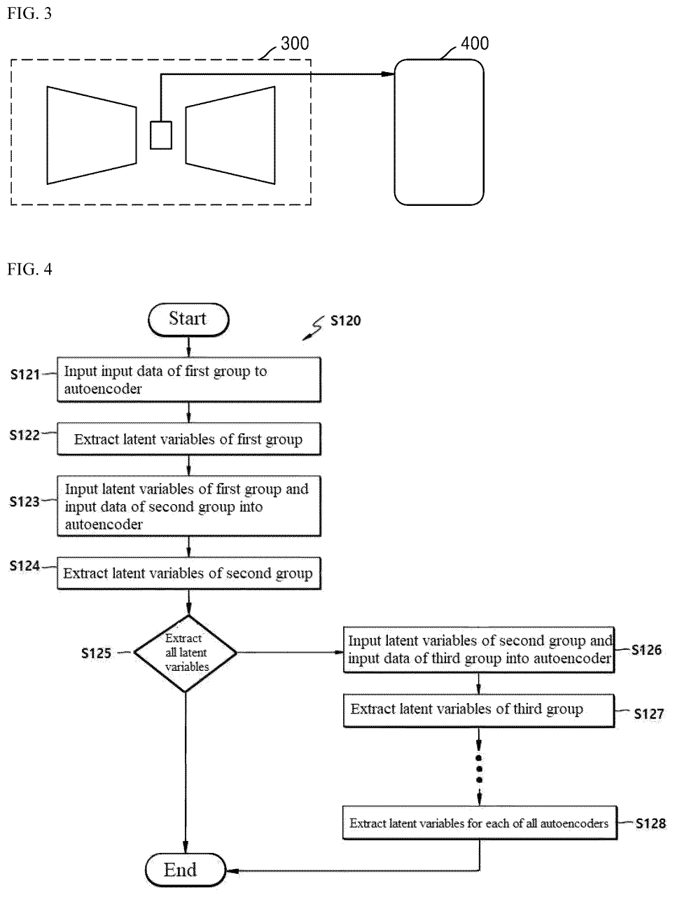

The model for predicting printing quality may be composed of the same number of autoencoders as the number of groups and a single deep neural network. The description of the printing quality prediction model will be described with reference to FIG. 3 and FIGS. 5 to 6.

The processor may input input data corresponding to each of the plurality of groups into each of the autoencoders. In more detail, the processor may input the input data corresponding to the first group that has the greatest influence on the printing quality into the first autoencoder to extract the first latent variable, and input the input data corresponding to the second group and the first latent variable into the second autoencoder to extract the second latent variable. In this way, the processor may input the input data corresponding to each of the plurality of groups into the autoencoder.

In addition, the processor may input the extracted plurality of latent variables into the deep neural network to obtain a value representing the printing quality.

For example, the latent variables may include the result of noise removal from the input data and the characteristics of the process factor.

The processor combines the input data and the latent variables extracted from the previous autoencoder and inputs them to the next autoencoder. For example, the latent variable extracted from the first autoencoder and the second input data are input to the second autoencoder. Therefore, according to the method of the present disclosure, the characteristics of the process factor affecting the printing quality may be reflected in the latent variables. In addition, since the latent variables are extracted based on the input data classified into the plurality of groups, the accuracy of the model for predicting printing quality may be improved.

The processor may obtain a label representing the printing quality using the output data output from the model (S130).

The output data represents a predicted value representing the printing quality in the range of 0 to 100%. In addition, the processor may match the output data with any one label (e.g., fail, low, medium, high, very high, etc.) according to a predetermined criterion. For example, if the output data is less than 60%, the processor may match it with a label called ‘fail’. In addition, if the output data is 60% or more but less than 70%, the processor may match it with a label called ‘low’. In addition, if the output data is 70% or more but less than 80%, the processor may match it with a label called ‘medium’. In addition, if the output data is 80% or more but less than 90%, the processor may match it with a label called ‘high’. In addition, if the output data is 90% or more, the processor may match it with a label called ‘very high’. Accordingly, a user may check the printing quality of the 3D printer according to the matched label.

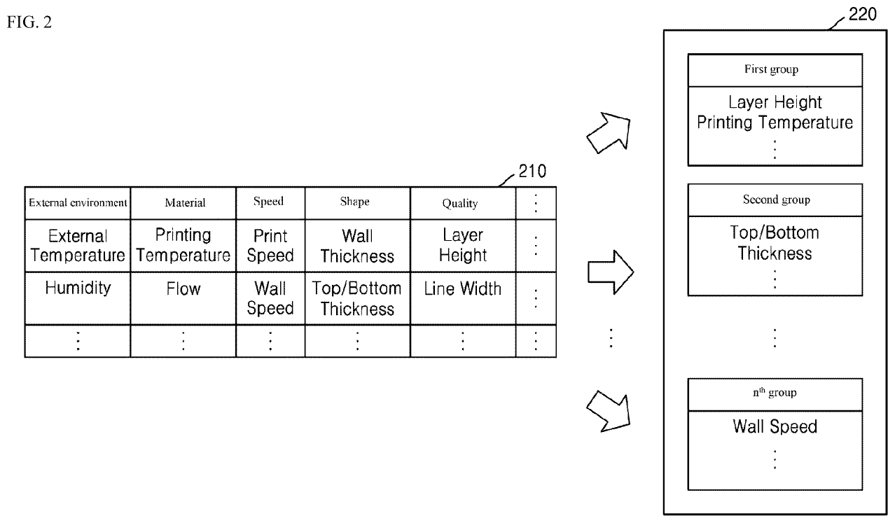

FIG. 2 is a diagram for explaining an example of classifying process factors of a 3D printer into a plurality of groups according to an embodiment of the present disclosure.

Referring to FIG. 2, process factors 210 may include various factors such as external environment (temperature and humidity), material (sample), output quality, and print speed.

As mentioned in step S110 of FIG. 1, the process factors 210 may be classified into a plurality of groups 220 according to the degree to which each process factor affects the printing quality.

In more detail, process factors classified into the first group among the plurality of groups 220 have the greatest effect on the printing quality. In addition, process factors classified into the n^{th} group have the least effect on the printing quality. Here, n means a natural number greater than or equal to 2.

The processor may normalize the process factors classified into the plurality of groups to generate input data, and may sequentially input the input data into a model for predicting printing quality.

FIG. 3 is a diagram for explaining an example of a model for predicting printing quality of a 3D printer configured to print food according to an embodiment of the present disclosure.

Referring to FIG. 3, the model for predicting printing quality may consist of a plurality of autoencoders 300 and a single deep neural network 400. The model for predicting printing quality has a structure in which latent variables extracted from the plurality of autoencoders 300 are input to the single deep neural network.

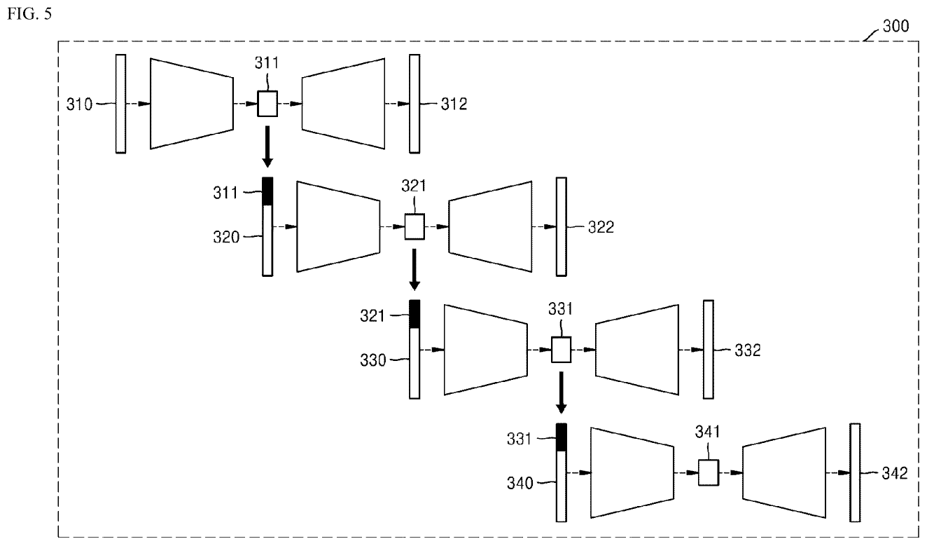

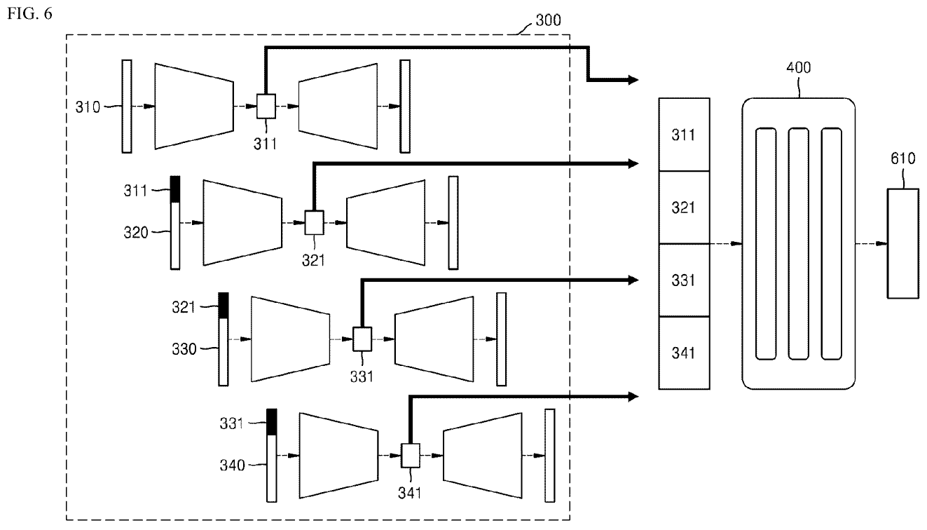

The number of autoencoders 300 may be the same as the number of the plurality of groups. However, for convenience of explanation, FIG. 3 illustrates one autoencoder 300 and a deep neural network 400. An example in which the model for predicting printing quality includes the plurality of autoencoders 300 is illustrated in FIG. 5.

The autoencoder 300 includes an encoder layer and a decoder layer. Each of the encoder layer and the decoder layer may include a plurality of hidden layers. The processor may compress input data and extract latent variables using a hidden layer included in the encoder layer. More specifically, the processor may compress the input data and extract latent variables including features that affect the printing quality of the output by the process factor.

In addition, the processor may restore the compressed input data using a hidden layer included in the decoder layer to generate output data. The output data generated by the decoder layer is used to train a model for predicting printing quality based on a backpropagation algorithm.

The processor may input the extracted latent variables into the deep neural network 400, and the output from the deep neural network 400 may be output data representing a printing quality prediction value.

FIG. 4 is a block diagram for explaining an example of extracting latent variables by a processor according to an embodiment of the present disclosure.

The processor may input input data included in the n^{th} group among the plurality of groups and a latent variable of the (n−1)^{th} group into an autoencoder to extract the n^{th} latent variable. Here, n is a natural number greater than or equal to 2 and refers to the number of classified groups.

In more detail, an example of extracting latent variables will be described with reference to FIG. 4.

The processor may input the input data of the first group into the autoencoder (S121). Thereafter, the processor may extract the latent variables of the first group (S122).

Thereafter, the processor may input the latent variables of the first group and the input data of the second group into the autoencoder (S123). Thereafter, the processor may extract the latent variables of the second group (S124).

In more detail, after extracting the latent variables of the first group, the processor may input the latent variables of the first group and the input data of the second group into the autoencoder to extract the latent variables of the second group.

The processor may determine whether all the latent variables have been extracted (S125). In more detail, the processor may determine whether the latent variables of all the autoencoders have been extracted. For example, if the number of groups classified for the process factor is n, the number of autoencoders may also be n. If the processor determines that the latent variables of all autoencoders have been extracted, the processor may input the extracted latent variables into the deep neural network.

If the processor determines that the latent variables of all autoencoders have not been extracted, the processor may input the latent variables of the second group and the input data of the third group into the autoencoder (S126). Then, the processor may extract the latent variables of the third group (S127).

In this manner, the processor repeats the above-described operation until the latent variables for each of all autoencoders are extracted (S128). For example, if the number of groups classified for the process factor is n, the processor may extract n latent variables through the autoencoder corresponding to the n classified groups. For example, if the number of classified groups is 4, the processor may extract 4 latent variables. Alternatively, if the number of classified groups is 5, the processor may extract 5 latent variables. If the processor repeats the above-described operation (S128) to extract the latent variables for each of all autoencoders, the extracted latent variables may be input into the deep neural network.

FIG. 5 is a diagram for explaining an example of inputting input data into a model for predicting printing quality according to an embodiment of the present disclosure.

Referring to FIG. 5, the model for predicting printing quality may include a plurality of autoencoders 300 corresponding to the plurality of groups. The processor may classify process factors into a plurality of groups and generate input data 310, 320, 330, 340 corresponding to the classification result. The processor may input the input data 310 of the first group into the autoencoder to extract a latent variable 311, and input the latent variable 311 and the input data 320 of the second group into the autoencoder by combining them. The processor may extract the latent variable 321, and input the latent variable 321 and the input data 330 of the third group into the autoencoder by combining them. In the same manner as described above, the processor may input the latent variable 331 and the input data 340 of the fourth group into the autoencoder and extract the latent variable 341.

According to an embodiment of the present disclosure, since the characteristics of the process factors that have the greatest influence on the printing quality affect all the latent variables, the accuracy of the model for predicting printing quality may be increased.

The output data 312, 322, 332, 342 of the autoencoder may be used in a backpropagation algorithm to reduce errors by comparing it with the input data 310, 320, 330, 340. The processor may train the model for predicting printing quality using the backpropagation algorithm.

FIG. 6 is a diagram for explaining an example of predicting printing quality using output data output from a prediction model according to an embodiment of the present disclosure.

Referring to FIG. 6, the model for predicting printing quality may consist of a plurality of autoencoders 300 corresponding to the plurality of groups and a single deep neural network 400.

The processor may input latent variables 311, 321, 331, 341 extracted from the plurality of autoencoders 300 into the deep neural network 400 and obtain output data indicating a printing quality prediction value from the deep neural network 400. The processor may obtain a label 610 indicating the printing quality corresponding to the output data.

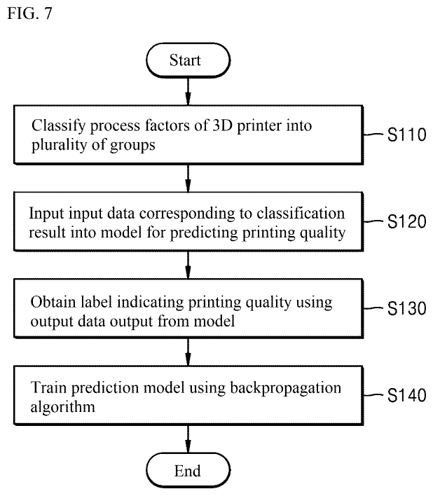

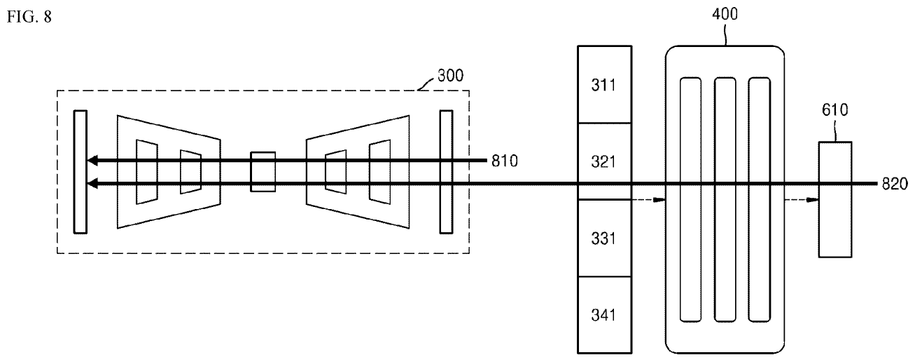

FIGS. 7 and 8 are diagrams for explaining an example of training a prediction model using a backpropagation algorithm according to an embodiment.

FIG. 7 is a block diagram for explaining an example of training a prediction model using a backpropagation algorithm according to an embodiment.

Referring to FIG. 7, steps S110 to S130 are identical to steps S110 to S130 of FIG. 1. Therefore, the description overlapping with FIG. 1 is omitted below.

The processor trains the prediction model using the backpropagation algorithm (S140).

For example, the processor may calculate a loss value using a loss function, and train the model for predicting printing quality based on the loss value. The loss function of the model for predicting printing quality may be configured as in [Formula 2] below by adding the loss values of each autoencoder and the overall loss value of the model for predicting printing quality.

$${Loss}_{Total} = {\sum }^{n} {Loss}_{{AE}_{n}} + {Loss}_{classification} \qquad [ Formula 2 ]$$

In Formula 2, Loss_{Ae}_{ₙ} represents the loss values of the plurality of autoencoders and Loss_{classification} represents the overall loss value of the model for predicting printing quality.

The proceeding direction of the backpropagation algorithm is opposite to the direction of obtaining the output data. The processor may proceed backpropagation in the deep neural network and the decoder layer of each autoencoder. In addition, the processor may perform backpropagation to the encoder layer of the autoencoder by combining the sum of the loss values of each autoencoder and the loss value of the deep neural network.

FIG. 8 is a diagram for explaining an example of training a prediction model using a backpropagation algorithm according to an embodiment of the present disclosure.

As described in FIG. 7, the backpropagation algorithm proceeds in the opposite direction to the direction in which the output data is obtained from the model for predicting printing quality.

Referring to FIG. 8, the processor may backpropagate (820) the loss generated in the deep neural network to the encoder layer of each autoencoder. In addition, the processor may backpropagate (810) the loss generated in each autoencoder only in each autoencoder. In the encoder layer present in each autoencoder, backpropagation may be proceeded by combining the loss of the autoencoder and the loss of the classification neural network.

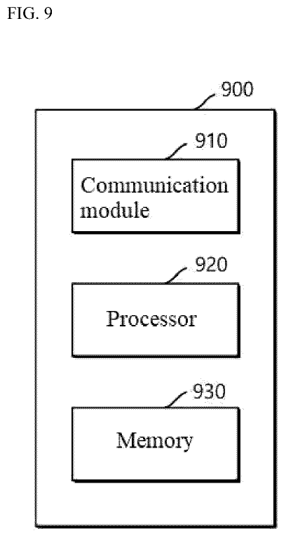

FIG. 9 is a block diagram illustrating a printing quality prediction apparatus according to an embodiment of the present disclosure.

Referring to FIG. 9, an apparatus 900 for predicting printing quality may include a communication module 910, a processor 920, and a memory 930. Only components related to the embodiment are illustrated in the apparatus 900 of FIG. 9. Therefore, it will be understood by those skilled in the art that other general components may be included in addition to the components illustrated in FIG. 9.

The communication module 910 may include one or more components that enable data communication between the apparatus 900 for predicting printing quality and an external device. For example, process factors (including process factor items and numerical values of process factors, etc.) may be received from the external device and provided to the processor 920 included in the apparatus 900 for predicting printing quality. Alternatively, the prediction result of printing quality obtained from the apparatus 900 for predicting printing quality may be provided to the external device. The communication module 910 may include at least one of a short-range communication module, mobile communication module, and the like.

The memory 930 is hardware that stores various types of data and may store a program for processing and controlling the processor 920. The memory 930 may store process factors classified into a plurality of groups, input data, latent variables, a model for predicting printing quality, etc.

The memory 930 may include a random access memory (RAM) such as a dynamic random access memory (DRAM), a static random access memory (SRAM), a read-only memory (ROM), an electrically erasable programmable read-only memory (EEPROM), a CD-ROM, a Blu-ray or other optical disk storage, a hard disk drive (HDD), a solid state drive (SSD), or a flash memory.

The processor 920 performs methods for predicting printing quality. For example, the processor 920 may control the communication module 910, the memory 930, etc., in general by executing programs stored in the memory 930.

The processor 920 may classify process factors of the 3D printer into a plurality of groups by executing programs stored in the memory 930, input the input data corresponding to the classification result into a model for predicting printing quality, and obtain a label indicating the printing quality by using the output data output from the model to predict the printing quality.

The processor 920 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

The above-described method may be written as a program that may be executed on a computer, and may be implemented in a general-purpose digital computer that operates the program using a non-transitory computer-readable recording medium. In addition, the structure of data used in the above-described method may be recorded on a non-transitory computer-readable recording medium through various means. The non-transitory computer-readable recording medium includes a storage medium such as a magnetic storage medium (for example, a ROM, a RAM, a USB, a floppy disk, a hard disk, etc.), an optical reading medium (for example, a CD-ROM, a DVD, etc.).

Those person skilled in the art related to the present embodiments will understand that the present disclosure may be implemented in a modified form without departing from the essential characteristics of the above-described description. Therefore, the disclosed methods should be considered from an illustrative rather than a restrictive perspective, and the scope of the rights is indicated by the appended claims rather than the above description, and should be construed to include all differences within the equivalent scope.

What is claimed is:

1. A method for predicting printing quality of a 3D printer configured to print food, wherein each step is performed by at least one processor included in a computing device, the method comprising:
classifying process factors of the 3D printer into a plurality of groups;
inputting input data corresponding to the classification result into a model for predicting the printing quality; and
obtaining a label indicating the printing quality by using output data output from the model.

2. The method according to claim 1, wherein the classifying comprises classifying the process factors into a plurality of groups based on a degree to which the process factors affect the printing quality.

3. The method according to claim 1, wherein the input data comprises data generated through normalization of the process factors.

4. The method according to claim 1, wherein the model comprises the same number of autoencoders as the plurality of groups and a single deep neural network.

5. The method according to claim 4, wherein the inputting of the input data corresponding to the classification result into the model for predicting the printing quality comprises:
obtaining latent variables output from each of the autoencoders; and
inputting the latent variables into the single deep neural network.

6. The method according to claim 5, wherein the obtaining of the latent variables comprises extracting an n^{th} latent variable by inputting input data included in an n^{th} group among the plurality of groups and a latent variable of an (n−1)^{th} group into the autoencoder,
wherein the n includes a natural number greater than or equal to 2.

7. The method according to claim 1, further comprising training the model using a backpropagation algorithm.

8. An apparatus for predicting printing quality of a 3D printer, the apparatus comprising:
a communication module configured to perform communication;
a memory in which at least one program is stored; and
a processor configured to perform an operation by executing the at least one program,
wherein the processor is configured to classify process factors of a food 3D printer into a plurality of groups, input data corresponding to the classification result into a model for predicting the printing quality, and obtain a label indicating the printing quality by using output data output from the model.

9. A non-transitory computer-readable recording medium having recorded thereon a program for executing the method according to claim 1 on a computer.
